(19) United States
(12) Patent Application Publication
(10) Pub. No.: US 2007/0124156 A1
(43) Pub. Date: May 31, 2007

(54) Representing business transactions

(75) Inventors: Jeff Rice, Edwardsville, IL (US); Stephen Su, St. Peters, MO (US); Thomas Renfert, Manchester, MO (US); Christina Hershberger, Saint Louis, MO (US)

Correspondence Address: John S. Beulick;Armstrong Teasdale LLP, Suite 2600, One Metropolitan Square, St. Louis, MO, 63102, US

(73) Assignee: The Boeing Company

(21) Appl. No.: 11/343,137

(22) Filed: Jan. 30, 2006

Related U.S. Application Data
(60) Provisional application No. 60/740,490, filed on Nov. 29, 2005.

(51) Int. Cl. G06Q 99/00; G06Q 40/00

(52) U.S. Cl. 705/1; 705/39

(57) ABSTRACT

Methods, systems, configurations, and computer program products create, represent, and manage Business Object Documents (BODs), coordinating the interfaces between two or more computer systems exchanging transactions thru a messaging architecture. The online validation of a BOD to prevent spoofing is performed by use of a relational database. While some aspects of the invention deal with the general e-business exchange of documents, others add versioning and verification to transactions via a repository that is used for that purpose. The repository is also used for the management of design of the electronic documents during the creations of the system between systems. Thru the use of a relational database business object document verification by relational repository (BODVRR) is able to perform automated validation of a versioned BOD in a business environment.

### RELATED APPLICATIONS

The present application claims priority to co-pending U.S. provisional patent application entitled “Representing Business Transactions” having Ser. No. 60/740,490, filed Nov. 29, 2005, which is entirely incorporated herein by reference.

### TECHNICAL FIELD

The present invention generally relates to representing business transactions and, more particularly, relates to methods, configurations, computer-readable mediums, and systems for verifying business object documents via a relational repository.

### BACKGROUND

A business object document (BOD) can be spoofed (a counterfeit BOD sent without a mechanism to validate its form) without validation. Previously, hard coded rules that perform validation become a maintenance and accuracy issue. This problem also becomes one of scale as the number of BODs used in an enterprise or industry grows into the hundreds and more with the application of BOD technology to electronic data interchange (EDI) like transactions.

Some conventional systems use a repository that stores XML as a single structure including an OAGIS BOD list at a gross level. The repository is XML oriented but it does not handle the storage and management of BODs. These conventional systems support the transposition from older to new versions of intelligent transport messages (ITMs), but not at runtime or for ITM translations between versions. These conventional systems also do not support an integrated editing and logical transposition of business objects.

For instance, Text Editors such as XMLSPY, POSEIDON, and MICROSOFT OFFICE WORD are all types of Text Editing tools. These text editors do not support a storage methodology. They support the transposition from older to new versions of the ITMs, but not at runtime. Similarly, Database Storage such as ORACLE, MICROSOFT ACCESS, and FOXPRO are all types of database storage tools. Although relational database technology may be supported by the above tools in order to store and manage the ITMs, these tools do not support a integrated editing and logical transposition of business objects.

Additionally, XML-based Graphical Editors such as XMLSPY, POSEIDON, MICROSOFT OFFICE WORD, and MICROSOFT VISIO are all types of XML-based Graphical Editing tools. These tools do not support a storage methodology. They support the transposition from older to new versions of the ITMs, but not at runtime. Similarly, XMLValidators such as XMLSPY, POSEIDON, MICROSOFT OFFICE WORD, and MICROSOFT VISIO are all types of XML Validation tools. These tools do not support a storage methodology. They support the validation or transposition from older to new versions of the ITMs, but not at runtime. Also, Versioning Tools such as CVS, MICROSOFT SOURCESAFE, and IBM CLEARCASE are all types of versioning tools. These tools do not supply a runtime component that allows for ITM translations between versions. They also do not allow for the transposition from older to new versions of the ITMs.

Accordingly there is an unaddressed need in the industry to address the aforementioned and other deficiencies and inadequacies.

### BRIEF DESCRIPTION OF THE DRAWINGS

FIG. 1 is a schematic diagram illustrating aspects of a networked operating environment and business object document verification by relational repository (BODVRR) architecture utilized in an illustrative embodiment of the invention;

FIG. 2 illustrates a data content architecture for an ITM utilized in an illustrative embodiment of the invention;

FIG. 3 illustrates a schematic diagram of a BODVRR and gateway platform according to an illustrative embodiment of the invention;

FIG. 4 illustrates an operational flow performed in representing business transactions according to an illustrative embodiment of the invention;

FIG. 5 illustrates a display utilized for viewing inputs and output of a repository according to an illustrative embodiment of the invention; and

FIGS. 5a-5c illustrate a block diagram of a service-oriented architecture (SOA) implemented by an SDS integration platform according to illustrative embodiments of the invention.

### DETAILED DESCRIPTION

As described briefly above, embodiments of the present invention provide methods, systems, configurations, and computer-readable mediums for representing business transactions. In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

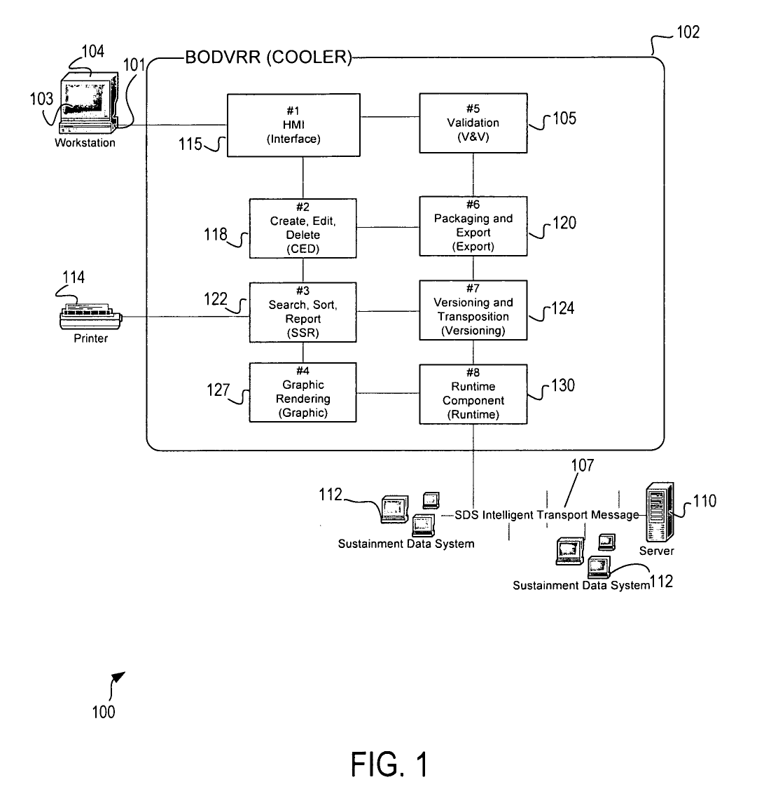

Referring now to the drawings, in which like numerals represent like elements through the several figures, aspects of the present invention and the illustrative operating environment will be described. FIGS. 1-3 and the following discussion are intended to provide a brief, general description of a suitable computing environment in which the embodiments of the invention may be implemented. While the invention will be described in the general context of program modules that execute in conjunction with a BIOS program that executes on a personal or server computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Aspects of the invention may be implemented as a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process. These and various other features as well as advantages, which characterize the present invention, will be apparent from a reading of the following detailed description and a review of the associated drawings.

An embodiment of the present invention is a computer program that organizes a collection of Business Object Documents (BODs) by the taxonomy of the verbs and nouns that make up the BOD. This program provides for the approval cycle between those requesting a standard BOD, the search on the complete BOD name, and the verb or the noun. In addition to the description of the BOD, the construct of the BOD is able to be stored in a variety of formats including xml, uml, and other binary formatted data in a blob format. This program also allows for the verification of a BOD in an application against the certified format in the BOD repository.

Referring now to a schematic diagram illustrating aspects of a networked operating environment 100 and business object document verification by relational repository (BODVRR) architecture 102 utilized in an illustrative embodiment of the invention, will be described. As shown in FIG. 1, the networked environment 100 includes sustainment data systems (SDS) 112, a server 110, an SDS intelligent transport message (ITM), a workstation 104, and a printer 114. A method for representing business transactions, creating & managing those representations, and for exchanging and processing of those transactions on one or more computers linked by a communications connection is illustrated. This communications connection may include both point to point and network connectivity of both wireless and wired technology.

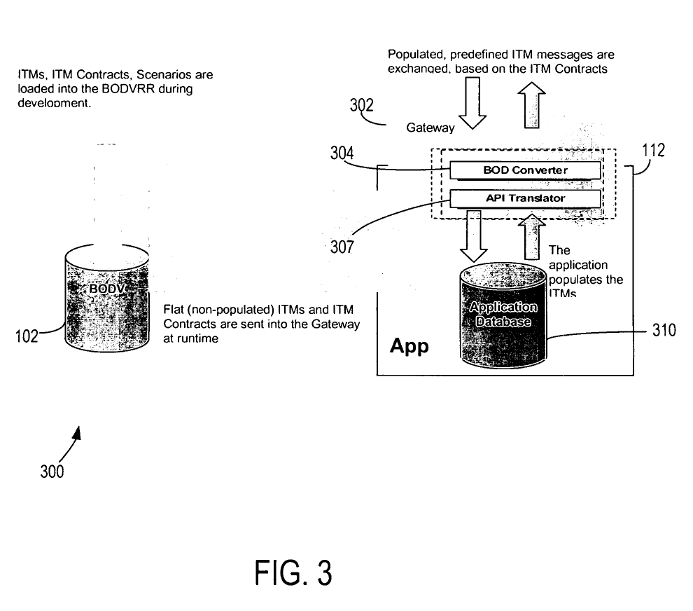

The operating environment 100 includes one or more computers, a computer network, a keyboard 101, and a display 103. Internally, the BODVRR 102 is divided into the following components: human-machine interface (HMI) 115, create, edit, delete capability (CED) 118, search, sort, report capability (SSR) 122, and graphic rendering 127. The BODVRR 102 also includes assemble, process, form validation capability (V&V) 105, packaging and export capability 120, versioning and translation capability 124, and runtime component for performing validation 130. The BODVRR 102 is an integrated development, storage, and control environment for intelligent transport contracts (ITCs) and ITMs. Additional details regarding the BODVRR 102 will be described below with respect to FIG. 3.

The application of relational database technology and business process methodology OAG suggested BOD approval process. BODVRR stores information in an external relational database for management purposes. This database 102 includes an automated approval process, search on name, verb or noun capability and the associated storage of the technical content of the BOD. The search, retrieval and management of stored version controlled BODs in the relational database allows them to be verified without going thru the user interface with appropriate security permission to the database. The automated creation of an XML schema for validation does not require the BODVRR 102 to be present in each system sending BODs. Additionally, the search capability 122 is available to locate content within the BOD Data fields or Binary Data.

It should be appreciated that the BODVRR 102 may be a redundant array of inexpensive discs (RAID) system for storing data. The BODVRR 102 is connected to a CPU through a mass storage controller (not shown) or network. The BODVRR 102 and its associated computer-readable media, provide non-volatile storage. Although the description of computer-readable media contained herein refers to a mass storage device, such as a hard disk or RAID array, it should be appreciated by those skilled in the art that computer-readable media can be any available media that can be accessed by the CPU.

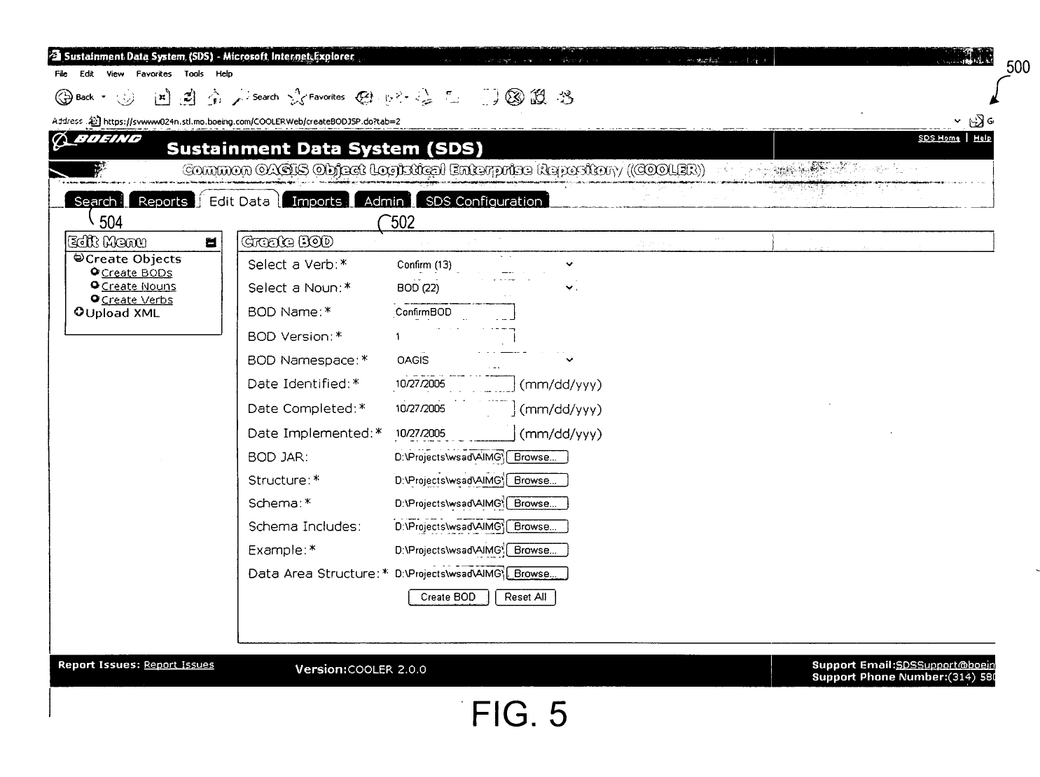

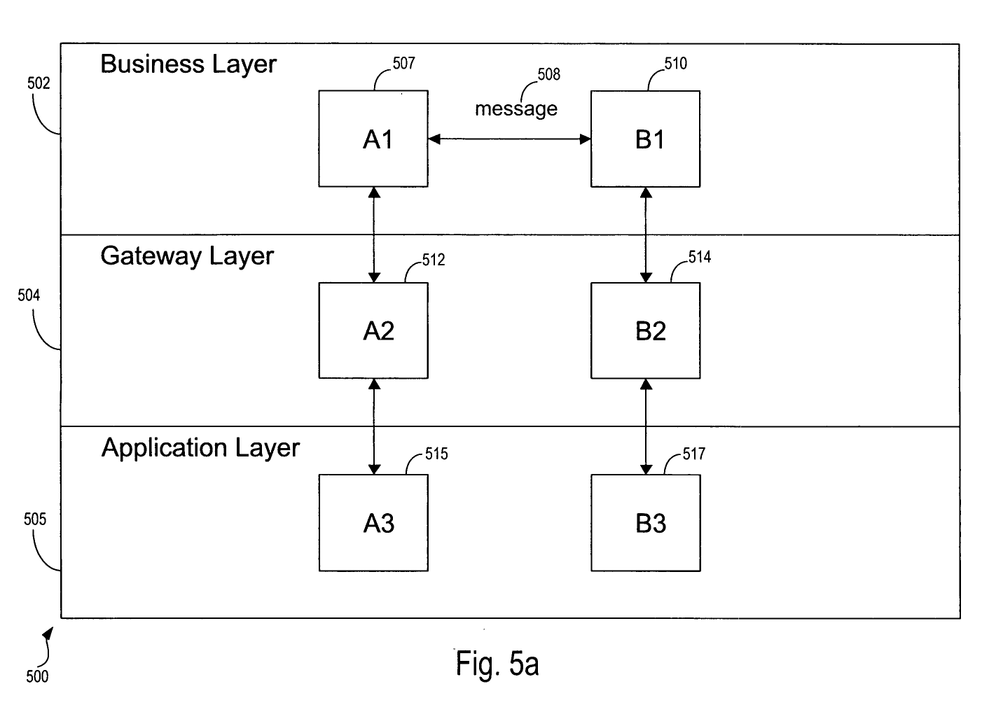

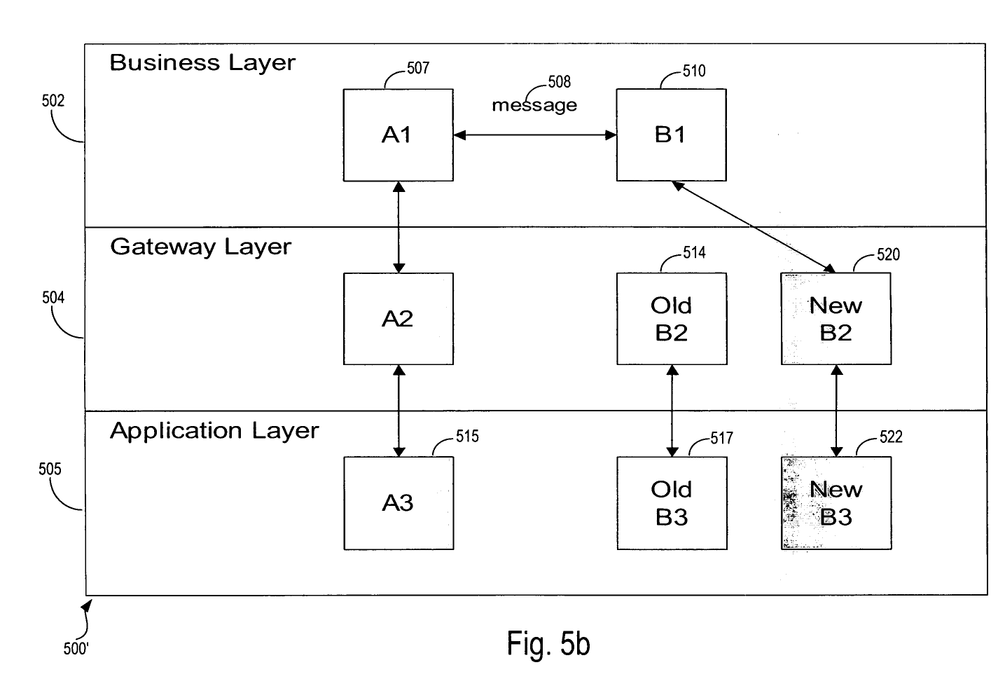

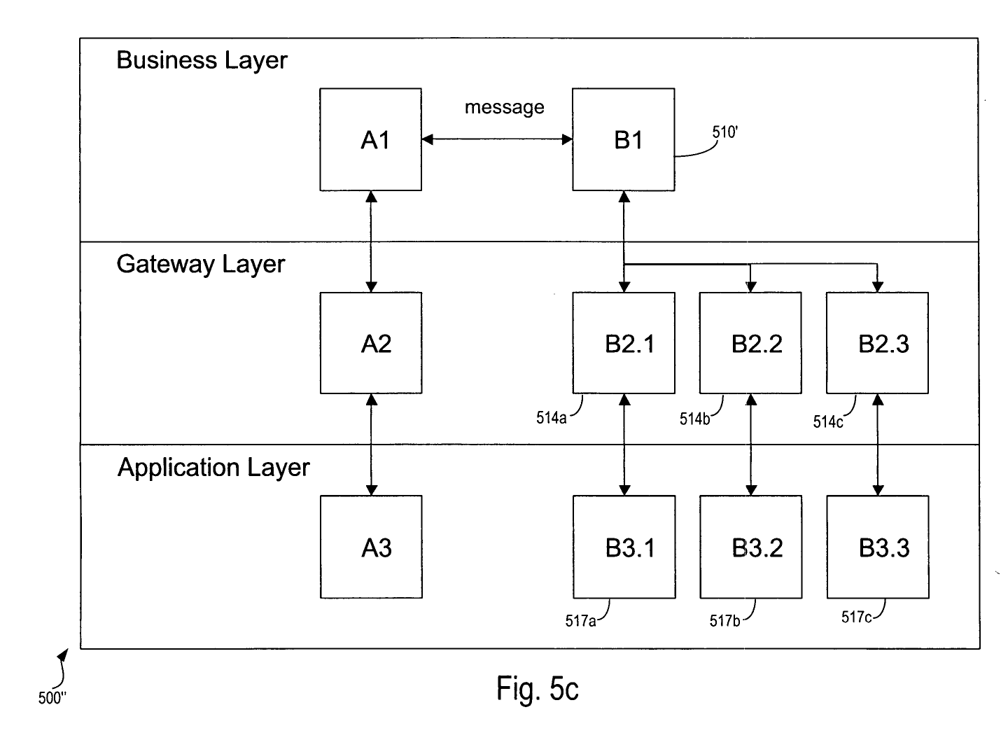

The CPU may employ various operations, discussed in more detail below with reference to FIG. 5 to provide and utilize the signals propagated between the BODVRR 102 and the SDS systems 112 (FIG. 1). The CPU may store data to and access data from BODVRR 102. The CPU may be a general-purpose computer processor. Furthermore as mentioned below, the CPU, in addition to being a general-purpose programmable processor, may be firmware, hard-wired logic, analog circuitry, other special purpose circuitry, or any combination thereof.

According to various embodiments of the invention, the BODVRR 102 operates in a networked or point to point environment, as shown in FIG. 1, using logical connections to remote computing devices via point to point or network communication. such as an Intranet, or a local area network (LAN). The BODVRR 102 may connect to the network via a network interface unit. It should be appreciated that the network interface unit may also be utilized to connect to other types of networks and remote computer systems.

A computing system, such as the BODVRR 102, typically includes at least some form of computer-readable media. Computer readable media can be any available media that can be accessed by the BODVRR 102. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the central server 104.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

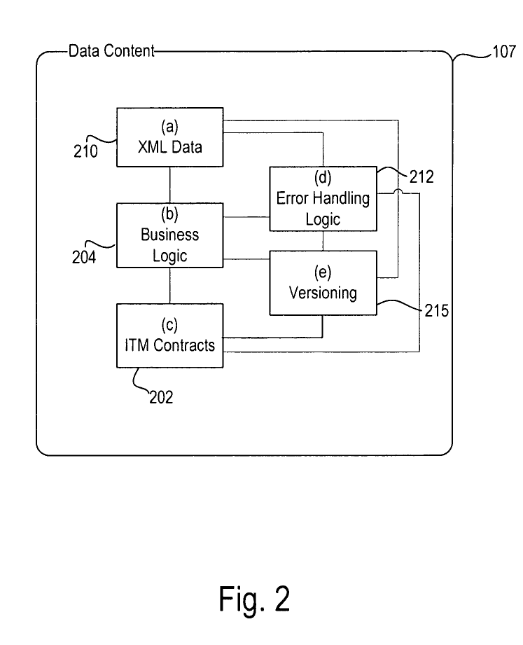

FIG. 2 illustrates a data content architecture for an ITM 107 utilized in an illustrative embodiment of the invention. An ITC is a business transaction contract to exchange data between two applications in a service-oriented architecture, importing data from outside of the system of systems (SOS) SOA and exporting from the SOS SOA. This contract will establish the following characteristics:
definition of data being exchanged;
translations required (language);
any conversions required (to adapt Message Version);
intermediate business processing of mutual benefit; and
security protocols required (encryption, user level authentication).

Referring still to FIG. 2, the ITM 107 includes data content based on an ITC between two or more systems, and will be represented by business transaction data formatted as XML-structured data 210, business transaction logic 204, business transaction constraints 202 (e.g. ITM contracts), and SOS SOA transaction error-handling logic 212. The ITM 107 may also include common error-handling logic, application-specific extensions to the common error handling logic, and versioning and transposition rules. The BODVRR 102 contains ITC and ITM documentation, including: design information, change history, change approval, change approver identification, XML, Unified Modeling Language (UML) scenarios, and deployment information. This is self-documenting.

The definition of an ITC and the ITM that transports it separates business information content from technical implementation and routing information. The ITM contains flags for security Protection and Export Control that provide for optional processing to encrypt an ITM or to log the transaction for regulatory compliance purposes. ITM manages transfers of data exceeding the maximum size of a single XML document through the use of external references to data stores that contain ITC payload.

FIG. 3 illustrates a schematic diagram of a BODVRR and gateway platform 300 according to an illustrative embodiment of the invention. ITMs, ITM contracts, and scenarios are loaded into the BODVRR 102 during development. The loading may occur via an SDS interface display (FIG. 5). Next, the non-populated or flat ITMs and ITM contracts are sent into a gateway 302 at runtime. Then, populated, predefined ITM messages are exchanged, based on the ITM contracts. An application 112 populates the ITMs via an API translator 307 and a BOD converter 304.

Text Editors such as XMLSPY, POSEIDON, and MICROSOFT OFFICE WORD are types of Text Editing tools. Unlike the BODVRR, they do not support a storage methodology. They support the transposition from older to new versions of the ITMs, but not at runtime as BODVRR does. Similarly, ORACLE, MICROSOFT ACCESS, FOXPRO, etc., are all types of Database storage tools. While BODVRR uses a relational database technology, which is supported by the above tools, to store and manage the ITMs, these tools do not support an integrated editing and logical transposition of business objects as BODVRR does.

Still further, XMLSPY, POSEIDON, MICROSOFT OFFICE WORD, MICROSOFT VISIO, etc., are all types of XML-based Graphical Editing tools. Unlike the BODVRR, they do not support a storage methodology. They support the transposition from older to new versions of the ITMs, but not at runtime. Additionally, XMLSPY, POSEIDON, MICROSOFT OFFICE WORD, MICROSOFT VISIO, etc., are all types of XML Validation tools. Unlike the BODVRR, they do not support a storage methodology. They support the validation or transposition from older to new versions of the ITMs, but not at runtime. Also, CVS, MICROSOFT SOURCESAFE, IBM CLEARCASE, etc., are all types of versioning tools. Unlike the BODVRR, they do not supply a runtime component that allows for ITM translations between versions. They also do not allow for the transposition from older to new versions of the ITMs. Embodiments of the present invention demonstrate the capabilities and overcome all the shortcomings of conventional systems in an integrated fashion.

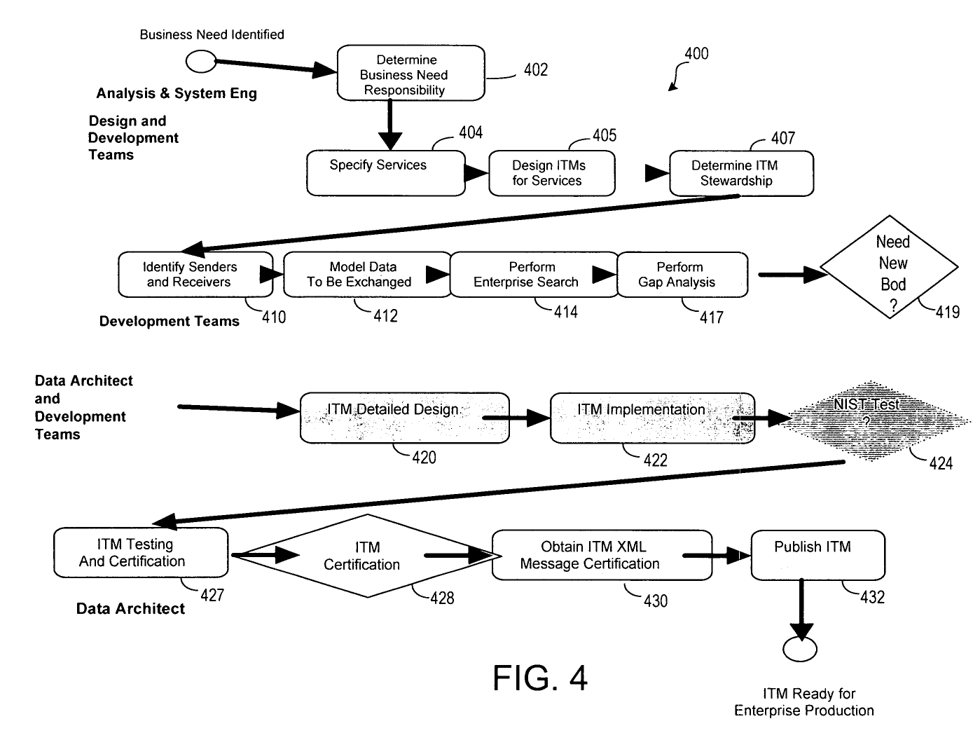

FIG. 4 illustrates an operational flow 400 performed in representing business transactions according to an illustrative embodiment of the invention. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 4, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The operational flow 400 begins at operation 402 where the BODVRR 102 determines business need responsibility. Next at operation 404, the BODVRR 102 specifies services associated with the responsibility. At operation 405 the BODVRR 102 designs ITMs for services. Then at operation 407, the BODVRR 102 determines ITM stewardship or ownership. The operational flow 400 then continues to operation 410.

At operation 410 the BODVRR 102 identifies senders and receivers associated with a business transaction. Then at operation 412, the BODVRR 102 models data to be exchange. At operation 414 the BODVRR 102 performs an enterprise search and a gap analysis at operation 417. Next, at operation 420 the BODVRR 102 generates a detailed ITM design.

At operation 422, the BODVRR 102 implements the ITM. Next at operation 424 the BODVRR 102 determines whether a National Institute of Standards (NIST) test has been made. The operational flow 400 then continues to operation 427 where ITMs are tested and certified. Next, at operation 428, the ITM is certified. At operation 430 the BODVRR 102 obtains ITM XML message certification and publishes the ITM at operation 432. The ITM is now ready for Enterprise production. BODVRR ITMs and ITCs must be reviewed and approved by the application integration administrator role before they will be used in production or included in the production extract.

FIG. 5 illustrates a display 500 utilized for viewing inputs and output of a repository according to an illustrative embodiment of the invention. The display 500 illustrates input fields for functionality 502 to create a BOD. Similarly, the display 500 includes other access tabs, such as the search tab 504. It should be appreciated that the display 500 is utilized to load BOD data outside of runtime. The BODVRR 102 controls the input, revision, reporting, and release of ITC and ITM through functional roles that persist permission categories to all functions of the BODVRR.

The BODVRR 102 also exports a selected subset of the ITC and ITM for use by an external interface program to verify the ITM is executing an approved ITC (e.g. the Validation capability. Additionally, the BODVRR administers the versioning of ITMs that are transmitted between applications. The business logic associated with an ITC can adapt between two different versions of the ITM when that conversion has been documented in the release of a new version. And BODVRR will provide the information where there is no valid contract between two different versions of an ITC and generate a standard error response that will be returned to the sending application.

FIGS. 5a-5c illustrate a block diagram of an SOA 500 implemented by an SDS integration platform according to illustrative embodiments of the invention. The SOA 500, in FIG. 5a, includes a business layer 502, a gateway layer 504, and an application layer 505. The business layer 502 includes logical subsystems, modules, or components of each integrated system of systems, such as logical subsystems A1 507 and B1 510. Physical communication between the integrated systems occurs via the business layer 502 utilizing reusable business transactions such as a message 508.

The gateway layer 504 includes gateways, such as gateways A2 512 and B2 514, which connect a logical subsystem of the business layer 502 with one or more applications of the application layer 505 such as applications A3 515 and B3 517. For instance the logical subsystem B1 510 is connected to the application B3 517 via the gateway 514. The gateway 514 regulates communication to and from the application B3 517. Thus, communication from the application A3 515 to the application B3 517 is routed via the business layer 502 through the gateways A2 and B2 to facilitate flexible changes to the application layer 505 with minimal changes to the business layer 502. Additional details regarding facilitating changes to the application layer 505 will be described below with respect to FIG. 5b.

FIG. 5b illustrates the SOA 500′ when a change to the application B3 517 occurs. When the application B3 517 is replaced by a new application B3 522, a new gateway B2 520 is also generated to regulate communication to and from the new application B3 522. For instance, the new gateway B2 translates, reformats, repackages, and/or filters source data in the form of a message such as the message 508 to be delivered to the new application B3. Similarly, when the new application B3 produces a result, the new gateway B2 translates, reformats, repackages, and/or filters the result to be presented in the form of a defined message or reusable business transaction. Applications can be replaced, without affecting the overall SDS system of systems, by selecting a new application, such as the new B3, implementing a new gateway, such as the new B2, and attaching the new gateway to a messaging or application adapter.

FIG. 5c illustrates the SOA 500″ according to another embodiment of the present invention. A single functional unit or logical subsystem, such as the logical subsystem B1 510′, may reside as a single component implemented using a single application within the SOA 500″. However, the single component may also be implemented sing a combination of applications, such as the applications 517a-517c, where each application is mediated by a gateway, such as gateways 514a-514c.

Thus, the present invention is presently embodied as methods, systems, computer program products or computer readable mediums encoding computer programs for representing a business transaction.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method for representing a business transaction, the method comprising:
determining a business need responsibility;
specifying services associated with the business need responsibility;
designing an intelligent transport message (ITM) for each of the services; and
determining an ITM stewardship for the ITM.

2. The method of claim 1, further comprising:
identifying at least one of senders or receivers; and
modeling data to be exchanged.

3. The method of claim 2, further comprising:
performing an enterprise search; and
performing a gap analysis.

4. The method of claim 2, further comprising:
determining whether a new business object document (BOD) is needed; and
in response to determining that a new BOD is needed, designing the new BOD.

5. The method of claim 1, further comprising:
designing a detailed ITM;
implementing the ITM;
testing and certifying the ITM utilizing the NIST test; and
obtaining an ITM XML message certification.

6. The method of claim 5, further comprising publishing the detailed ITM.

7. The method of claim 1, further comprising exchanging and processing the business transaction on one or more computers linked by a communications connection wherein upon replacing at least one application of an application layer with a new application, exchanging and processing the business transaction comprises:
locating the new application;
configuring an application integration gateway to mediate communication of the business transaction to and from the new application; and
connecting the gateway between the new application and a business integration component to facilitate exchanging the business transaction to and from the new application and a business layer via the gateway.

8. The method of claim 7, wherein the communications connection includes both point to point and network connectivity of both wireless and wired technology.

9. The method of claim 1, wherein designing the ITM comprises designing data content based on an intelligent transport contract (ITC) between two or more systems and wherein the ITM is represented by at least one of the following:
business transaction data formatted as XML-structured data;
business transaction logic;
business transaction constraints;
system of systems (SOS) service oriented architecture (SOA) transaction error-handling logic;
common error-handling logic;
application-specific extensions to the common error handling logic; and
versioning and transposition rules.

10. The method of claim 9, wherein the ITC comprises a business transaction contract to exchange data between two applications in a SOA therein importing data from outside of the SOS SOA and exporting data from the SOS SOA.

11. The method of claim 10, wherein the ITC establishes at least one of the following characteristics:
definition of data being exchanged;
translations required;
any conversions required to adapt a message version;
intermediate business processing of mutual benefit; and
security protocols required.

12. A computer program product comprising a computer-readable medium having control logic stored therein for causing a computer to represent business transactions, the control logic comprising computer-readable program code for causing the computer to:
determine a business need responsibility;
specify services associated with the business need responsibility;
design an intelligent transport message (ITM) for each of the services; and
determine an ITM stewardship for the ITM.

13. The computer program product of claim 12, further comprising computer-readable program code for causing the computer to:
identify at least one of senders or receivers; and
model data to be exchanged.

14. The computer program product of claim 12, further comprising computer-readable program code for causing the computer to control input, revision, and release of ITC and ITM through functional roles that persist permission categories to all functions of a business object document verification by relational repository (BODVRR).

15. The computer program product of claim 12, further comprising computer-readable program code for causing the computer to export a selected subset of the ITC and ITM for use by an external interface program to verify the ITM is executing an approved ITC.

16. The computer program product of claim 12, further comprising computer-readable program code for causing the computer to administer versioning of ITMs that are transmitted between applications.

17. The computer program product of claim 12, further comprising computer-readable program code for causing the computer to:
provide information where there is no valid contract between two different versions of an ITC; and
generate a standard error response that will be returned to a sending application.

18. The computer program product of claim 12, further comprising computer-readable program code for causing the computer to manage transfers of data exceeding a maximum size of a single XML document through use of external references to data stores that contain an ITC payload.

19. A computer-implemented system for representing business transactions, the system comprising:
one or more computers;
a computer network;
a keyboard; and
a display; and
a BODVRR operative to:
interface human and machine;
create, edit, and delete ITCs and ITMs;
search, sort, and report ITMs; and
render graphics.

20. The system of claim 19, wherein the BODVRR is further operative to:
assemble, process, and form validate business transactions;
package and export ITMs;
version and translate ITCs; and
perform validation via a runtime component.
